(19) United States
(12) Patent Application Publication
(10) Pub. No.: US 2025/0337495 A1
(43) Pub. Date: Oct. 30, 2025

(54) APPARATUS AND METHOD FOR AI-ASSISTED EDFA GAIN CONTROL

(71) Applicant: HUAWEI TECHNOLOGIES CO., LTD., Shenzhen (CN)

(72) Inventors: Zhiping JIANG, Kanata (CA); Lixian WANG, Quebec (CA)

(21) Appl. No.: 18/929,791

(22) Filed: Oct. 29, 2024

Related U.S. Application Data
(60) Provisional application No. 63/638,464, filed on Apr. 25, 2024.

(51) Int. Cl. H04B 10/294; H01S 3/067

(52) U.S. Cl. CPC H04B 10/2942; H01S 3/06754

(57) ABSTRACT

An optical system, comprising a detection unit for detecting an input signal power profile; an algorithm unit for acquiring information of the input signal power profile and calculating a set of optimal control parameters for an EDFA along a link of the optical system; a link controller for acquiring the information of the set of optimal control parameters of the EDFA and configuring the EDFA.

### CROSS-REFERENCE

The present application claims priority on U.S. Patent Application No. 63/638,464, entitled “APPARATUS AND METHOD FOR AI-ASSISTED EDFA GAIN CONTROL”, filed on Apr. 25, 2024, and the content of which is incorporated herein by reference in its entirety.

### FIELD

The present technology relates generally to telecommunication, and more particularly, to apparatuses and methods for AI-assisted EDFA again control.

### BACKGROUND

Optical systems equipped with an Erbium-Doped Fiber Amplifier (EDFA) are designed to boost signal strength in fiber-optic networks. At the heart of these systems is the erbium-doped fiber, which uses erbium ions to amplify incoming light signals. This amplification process is energized by a pump laser, which typically emits at wavelengths of 980 nm or 1480 nm, for exciting the erbium ions. Such systems may include Wavelength Division Multiplexing (WDM) components to manage signal and pump wavelengths efficiently, and optical isolators to prevent signal feedback and maintain system integrity. Optical connectors and splices may also be used to ensure low-loss connections between the fiber segments, while control electronics may regulate the pump laser and monitor system performance to optimize amplification. In one non-limiting application, such systems may be used to extend the reach and capacity of long-haul and metropolitan fiber optic networks, reducing the need for electronic regeneration and thus enhancing overall network efficiency.

Most of EDFAs, such as inline amplifiers (ILAs) installed in the long-haul optical telecommunication system, for example, work under the “gain locking” mode, in which the averaged gain and the gain tilt (under full loading) are locked to pre-set values to compensate for the transmission loss and the stimulated Raman scattering (SRS) effect. With the gain settings fixed, EDFAs may exhibit random-like gain shape distortions under scenarios such as channel add/drop and fiber breakage power loss due to the variation of the Er3+ ions' averaged inversion level as well as due to the spectral hole burning (SHB) effect in the EDF. As a result, signal quality may degrade, and make the system instable and operationally inefficient (e.g. resource over-provision).

Some EDFA system can integrate AI models. Various types of Neural Network (NN) based EDFA gain models are known.

### SUMMARY

Developers have devised methods and processors for overcoming at least some drawbacks present in prior art solutions.

Developers of the present technology have realized that known EDFAs integrated NNs are mostly “set it and forget it” module. The control parameters, such as the averaged gain level (dependent on the pump powers) and the gain tilt (controlled by the signal attenuation induced by the amplifier's built-in variable optical attenuator (VOA)) are usually considered as constants. EDFAs' settings are only optimized for a full loading case. Developers have devised methods and systems for improving gain control of EDFAs to bring EDFA's gain profile, under partial loading, closer to the best case scenario for the optical system.

In the context of the present technology, an EDFA refers to a device used predominantly in fiber optic communication systems to amplify light signals without converting them to electrical signals. It utilizes a fiber that is doped with erbium ions, which are excited by a pump laser at specific wavelengths, such as 980 nm or 1480 nm, for example. This excitation boosts the energy level of the erbium ions, which then amplify incoming optical signals by stimulated emission at around 1550 nm, for example, a common telecommunications wavelength due to its low loss in silica fiber.

In the context of the present technology, a Variable Optical Attenuator (VOA) refers to a device used in fiber optic communications to manage the power level of optical signals. Power level management may be used for balancing signal strength in a network to prevent overloading optical receivers and/or for testing and measurement purposes. VOAs can be manually or electronically adjusted to change the attenuation level, thus controlling the intensity of the signal that passes through it.

In the context of the present technology, an Inline Amplifier (ILA) refers to a device used in optical networks to amplify signals directly on the transmission path without the need for optical-electrical-optical conversion. These amplifiers are strategically placed along fiber optic routes to restore signal strength diminished by loss due to propagation, especially in long-haul transmissions. These devices may be used for maintaining high-quality communication over large distances.

In the context of the present technology, Spectral Hole Burning (SHB) refers to a phenomenon that occurs in the gain spectrum of an optical amplifier, such as an EDFA, where certain wavelengths experience reduced amplification. This can happen when intense signals at specific wavelengths deplete the available energy states of the amplifying medium more than signals at other wavelengths, leading to uneven signal amplification across the spectrum.

In the context of the present technology, a Neural Network (NN) refers to a computational model inspired by the structure of the human brain. It consists of interconnected nodes (neurons) that process input data through layers to produce an output. NNs are models often used in artificial intelligence and machine learning, enabling tasks such as image and speech recognition, natural language processing, and predictive analytics, for example.

In the context of the present technology, Stimulated Raman Scattering (SRS) refers to a nonlinear optical effect observed when intense light waves travel through a medium, causing vibrations in the medium's molecules that shift the light's wavelength. In fiber optics, for example, SRS can affect signal quality by transferring energy from short to long wavelengths, thus leading to cross-talk and signal degradation over long distances.

In the context of the present technology, Wavelength Selective Switch (WSS) refers to a device used in Wavelength Division Multiplexing (WDM) systems to dynamically route different wavelength channels of light into different directions. This capability may be used for managing bandwidth and routing in complex networks, allowing for efficient utilization of optical fiber capacity and flexibility in network design.

In the context of the present technology, Reconfigurable Optical Add-Drop Multiplexer (ROADM) is a device that enables dynamic remote configuration of the wavelengths routed through an optical network. It can add, block, pass and/or redirect light beams of various wavelengths in a fiber optic system, facilitating versatile and manageable network bandwidth provisioning.

In the context of the present technology, Optical Multiplex Section (OMS) refers to a segment within a fiber optic transmission system. It consists of a ROADM, transmission fibers and ILAs.

In the context of the present technology, an Optical Supervisory Channel (OSC) refers to a separate wavelength channel used in WDM systems for management and control purposes. It carries information about the system's status and performance, allowing network operators to monitor, troubleshoot, and optimize the network remotely without affecting the data-carrying channels.

In the context of the present technology, a Light Sensor (LS) refers to a device in fiber optics that detects light signals and converts them into electronic data that can be measured and analyzed. Light sensors may be used for monitoring and maintaining the integrity of optical communications, as they help ensuring that the light levels within the system remain within operational parameters.

In the context of the present technology, a Pilot Tone (PT) refers to a continuous wave signal of a specific frequency that is added to an optical signal. It is used for various control and monitoring purposes, such as signal identification, performance monitoring, and for synchronization in coherent transmission systems.

In the context of the present technology, a Radio Frequency Modulation (RFM) refers to the modulation of light signals at radio frequencies to transmit data over optical fibers.

Developers of the present technology have realized that existing AI-EDFA models are purely descriptive black box models—that is, they do not intervene during EDFA control. In some embodiments, methods and systems are devised to minimize EDFA's gain change under channel loading change. In some embodiments of the present technology, one or more NN models are used for the fine-tuning and/or for optimizing the EDFA's gain profile.

In some embodiments of the present technology, there is provided a detection unit that detects the input signal power profile. The detection unit can be based on an LS detector. Alternatively, the detection unit can be based on a spectrometer. Optionally, the detection unit can be located in the Reconfigurable Optical Add-Drop Multiplexer (ROADM) station. It is contemplated that a plurality of detection units may be integrated in an amplification station.

In some embodiments of the present technology, there is provided an algorithm unit that takes the information of the input signal power profile and calculate the optimal control parameters for the EDFAs along the link. The algorithm unit comprises an NN model for the entire EDFA. The control algorithm may combine the NN model with the physical model to calculate the optimal averaged gain level and the optimal VOA attenuation for the EDFA, so as to minimize the gain deviation for the signal channels.

In further embodiments, the algorithm unit may comprise a complex NN model, in which, each amplification stage has its own NN model and each NN model is trained for nonuniform signal input. The complex NN model takes the input signal power profile, the pump powers and the VOA attenuation as the inputs, and predicts the signal gain and the output signal power profile.

Optionally, the algorithm unit comprising the complex NN model may have a control algorithm implemented as a monitoring-based algorithm. It takes the initial input signal power profile and the current input signal power profile as the input. These two inputs have some time delay. The control model uses the EDFA's NN model to tune the pump powers and the VOA to minimize the gain change.

Alternatively, the algorithm unit comprising the complex NN model may have a control algorithm implemented as a software-based algorithm. It takes the initial input signal power profile and the final input signal power profile as the input. The control model uses the EDFA's NN model to tune the pump powers and the VOA to minimize the gain change.

In some embodiments of the present technology, there is provided a link controller that takes the information of the optimal control parameters of the EDFAs and configure the EDFAs along the link. It is contemplated that the link controller can be located in the ROADM station. The link controller may use the OSC to communicate with the EDFAs along the link. Optionally, a plurality of link controllers may be provided, each of which is integrated in an amplification station (e.g., an EDFA controller).

In some embodiments of the present technology, there is provided an amplification station comprising one or more EDFAs, one or more detection units for detecting the input signal power profile, one or more algorithm units for calculating the optimal EDFA control parameters, and one or more EDFA controllers that take the output(s) of the one or more algorithm units and re-configure the one or more EDFAs.

In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts an architecture of an optical system in accordance with some non-limiting embodiments of the present technology.

FIG. 2 depicts an LS-based detection unit, in accordance with a first embodiment of the present technology.

FIG. 3 depicts a spectrometer-based detection unit, in accordance with a second embodiment of the present technology.

FIG. 4 depicts a Link Controller using an OSC to communicate with the EDFAs along a link, in accordance with a third embodiment of the present technology.

FIG. 5 depicts a Detection Unit and an Algorithm Unit integrated within an amplifier module or within an amplifier station, in accordance with a fourth embodiment of the present technology.

FIGS. 6A and 6B depict one NN model used for an amplifier and a corresponding control algorithm, in accordance with a fifth embodiment of the present technology

FIGS. 7A and 7B depict an NN model within which each stage has its own NN model and wherein monitoring-based algorithm is used where the current channel loading is known, and a final channel loading is unknown, in accordance with a sixth embodiment of the present technology.

FIGS. 8A and 8B depict an NN model within which each stage has its own NN model and wherein a software-based algorithm is used where the final channel loading is known, in accordance with a seventh embodiment of the present technology.

FIG. 9 is a Multi-Layer Perceptron (MLP) architecture, which is a type of NN architecture, that can be used in at least some embodiments of the present technology.

FIG. 10 illustrates an example of a computing device that may be used to implement any of the methods described herein.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

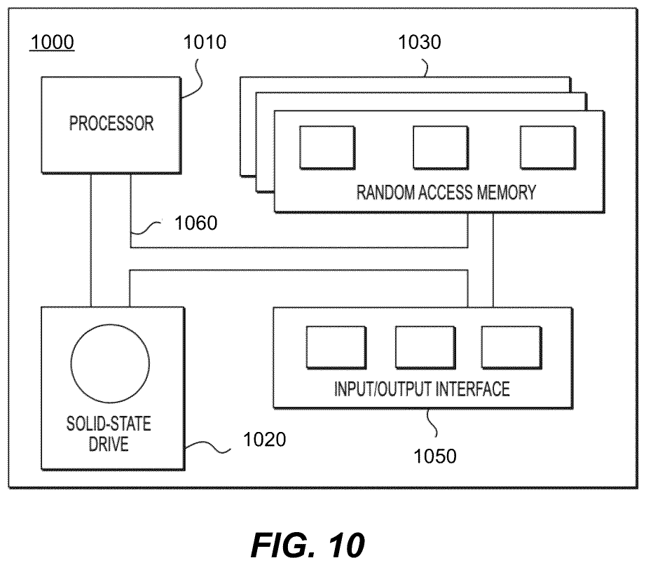

### FIG. 10—Computing Environment

FIG. 10 illustrates a diagram of a computing environment 1000 in accordance with an embodiment of the present technology is shown. In some embodiments, the computing environment 1000 may be implemented by any of a conventional personal computer, a computer dedicated to operating and/or monitoring systems relating to a data center, a controller and/or an electronic device (such as, but not limited to, a mobile device, a tablet device, a server, a controller unit, a control device, a monitoring device etc.) and/or any combination thereof appropriate to the relevant task at hand. In some embodiments, the computing environment 1000 comprises various hardware components including one or more single or multi-core processors collectively represented by a processor 1010, a solid-state drive 1020, a random access memory 1030 and an input/output interface 1050.

In some embodiments, the computing environment 1000 may also be a sub-system of one of the above-listed systems. In some other embodiments, the computing environment 1000 may be an “off the shelf” generic computer system. In some embodiments, the computing environment 1000 may also be distributed amongst multiple systems. The computing environment 1000 may also be specifically dedicated to the implementation of the present technology. As a person in the art of the present technology may appreciate, multiple variations as to how the computing environment 1000 is implemented may be envisioned without departing from the scope of the present technology.

Communication between the various components of the computing environment 1000 may be enabled by one or more internal and/or external buses 1060 (e.g. a PCI bus, universal serial bus, IEEE 1394 “Firewire” bus, SCSI bus, Serial-ATA bus, ARINC bus, etc.), to which the various hardware components are electronically coupled.

The input/output interface 1050 may allow enabling networking capabilities such as wire or wireless access. As an example, the input/output interface 1050 may comprise a networking interface such as, but not limited to, a network port, a network socket, a network interface controller and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

In some embodiments of the present technology, the computing environment 1000 may be implemented as part of a cloud computing environment. Broadly, a cloud computing environment is a type of computing that relies on a network of remote servers hosted on the internet, for example, to store, manage, and process data, rather than a local server or personal computer. This type of computing allows users to access data and applications from remote locations, and provides a scalable, flexible, and cost-effective solution for data storage and computing. Cloud computing environments can be divided into three main categories: Infrastructure as a Service (IaaS), Platform as a Service (PaaS), and Software as a Service (Saas). In an IaaS environment, users can rent virtual servers, storage, and other computing resources from a third-party provider, for example. In a PaaS environment, users have access to a platform for developing, running, and managing applications without having to manage the underlying infrastructure. In a SaaS environment, users can access pre-built software applications that are hosted by a third-party provider, for example. In summary, cloud computing environments offer a range of benefits, including cost savings, scalability, increased agility, and the ability to quickly deploy and manage applications.

In the context of a present technology, it is contemplated that the processor 110 is configured to execute computer-readable instructions that cause the processor 110 to execute one or more steps of a computer-implemented method. In some cases, computer-readable instructions may be associated with one or more algorithms running on the computing environment 100. For example, software applications may be running on the computing environment 100 based on which the processor 110 can be caused to execute one or more steps of a computer-implement method. Method steps executable by the processor 110 based on one or more algorithms or software applications running in the computing environment 100 will become apparent from the description herein further below.

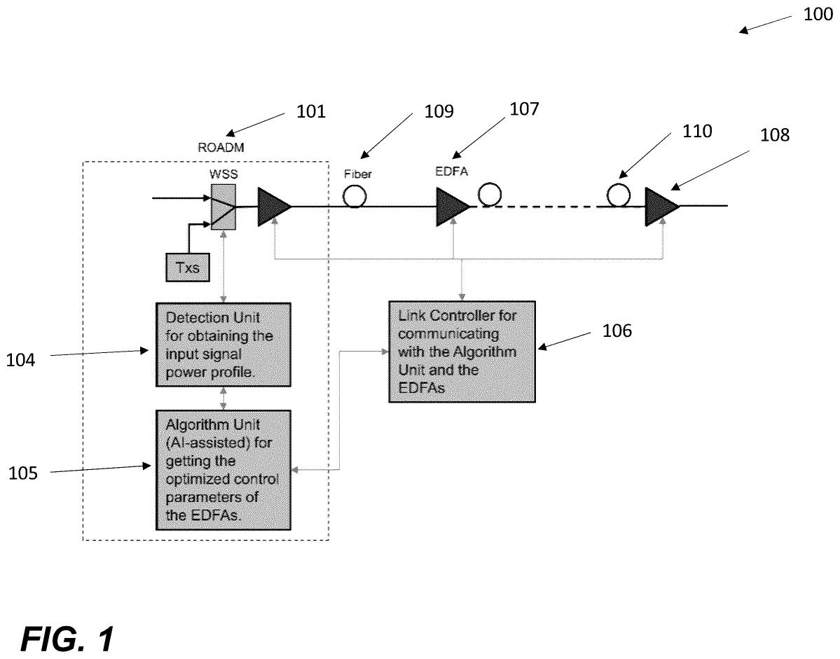

### FIG. 1—General Architecture

With reference to FIG. 1, there is depicted an architecture of an optical system 100 in accordance with at least some non-limiting embodiments of the present technology. The optical system 100 comprises an OMS section, which contains a Reconfigurable Optical Add-Drop Multiplexer (ROADM) 101 followed by several sections of amplifiers 107, 108 and transmission fibers 109, 110.

The ROADM station comprises a Detection Unit 104 which is able to obtain a signal power profile that is injected into the series of amplifiers 107, 108 and transmission fibers 109, 110. The Detection Unit 104 is configured to send the information of the signal power profile to an Algorithm Unit 105 which calculates the optimized control parameters of amplifiers (EDFAs) 107, 108. The Algorithm Unit 105 is configured to send the optimized control parameters to a Link Controller 106, which then configures the EDFAs 107, 108 along the link to their optimized working points.

In at least some embodiments of the present technology, it is contemplated that the architecture of the optical system 100 may be able to detect the input channel power profile, process the information of the input channel power profile and obtain the optimized control parameters of the EDFAs 107, 108, and configure the EDFAs 107, 108 using these control parameters, so that their gain profiles will be close to an optimal case required by the entire system. “An optimal case” means that the gain profile guarantees a best possible signal to noise ratio of the entire optical transmission system. More specifically, it can be explained as the following: for an optical transmission system, there are two main sources of noise. One is the amplified spontaneous emission (ASE) noise generated by the EDFAs 107, 108, the other one is the nonlinear noise generated by the nonlinear effect of the transmission fibers, such as the self phase modulation (SPM) effect. When the signal power increases, the SNR contributed by the ASE noise gets improved, but on the other hand, the signal to noise ratio (SNR) contributed by the nonlinear noise degrades. In order to obtain as high as possible the SNR of the signal, the optical power of the signal launched into the transmission needs to be optimized, not too low nor too high. The gain of the EDFAs 107, 108 play a role and need to be well controlled so that for each signal channel, the signal launch power is as close as possible to the optimal point.

In at least some embodiments of the present technology, it is contemplated that the architecture of the optical system 100 may execute one or more optimization algorithms that combine both the AI-model and the physics model of an EDFA. Such algorithms may be able to predict the EDFA's gain profile as well as to obtain the optimal control parameters of the EDFAs 107, 108.

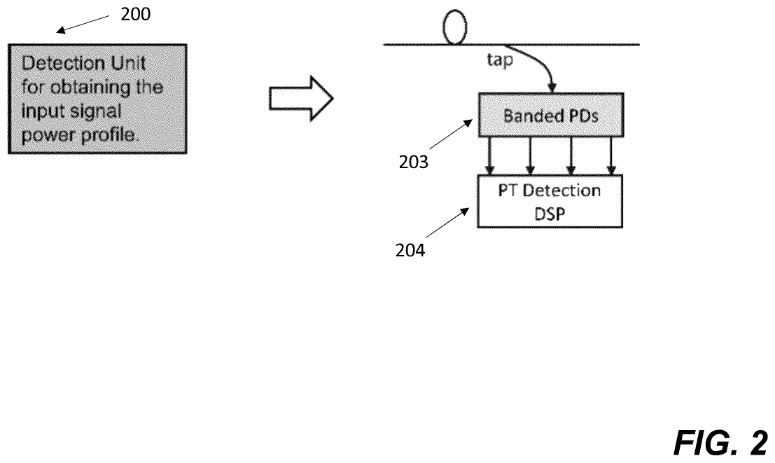

### FIG. 2—Embodiment 1

With reference to FIG. 2, there is depicted a detection unit 200 in accordance with a first embodiment of the present technology. The detection unit 200 is embodied as an LS-based detection unit. The LS technology refers to the technology that, at the transmitter, a radio frequency is modulated on top of the optical signal. This modulation is realized within the optical transmitter. A unique radio frequency is assigned to each optical signal wavelength. For example, the amplitude of the optical signal of 1550 nm is modulated by a radio frequency of, say, 1 MHz, while the amplitude of the other optical signal of 1560 nm is modulated by a radio frequency of, say, 1.5 MHz. By detecting the amplitudes of the radio frequencies, the power of the optical signal channels can be known. The detection unit 200 de-modulate the radio frequency signal, i.e. the so-called “Pilot Tone (PT)”, out from the optical signal, in order to extract the information of the signal power profile. In some embodiments, the detection unit 200 may use banded photodetectors 203 to detect PTs, and may use PT detection digital signal processing (DSP) module 204 to extract strengths of the PTs, and determine the corresponding signal power profile.

Developers have realized that employing an LS-based detection unit is a relatively low cost solution, having a small form-factor, and is relatively fast (˜10 ms).

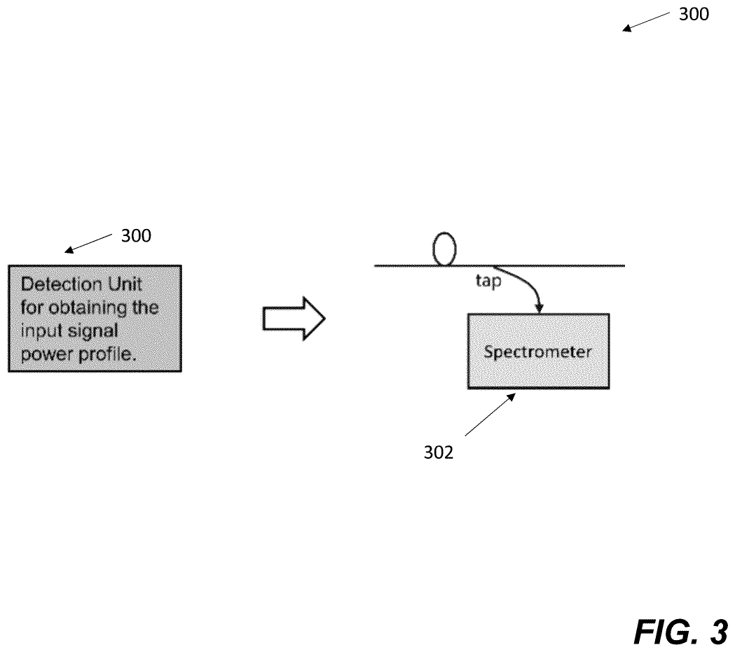

### FIG. 3—Embodiment 2

With reference to FIG. 3, there is depicted a detection unit 300 in accordance with a second embodiment of the present technology. The detection unit 300 is embodied as a spectrometer 302. Developers have realized that employing a spectrometer may increase a precision of the power spectrum detection in comparison to an LS-based detection unit, such as the detection unit 200, for example.

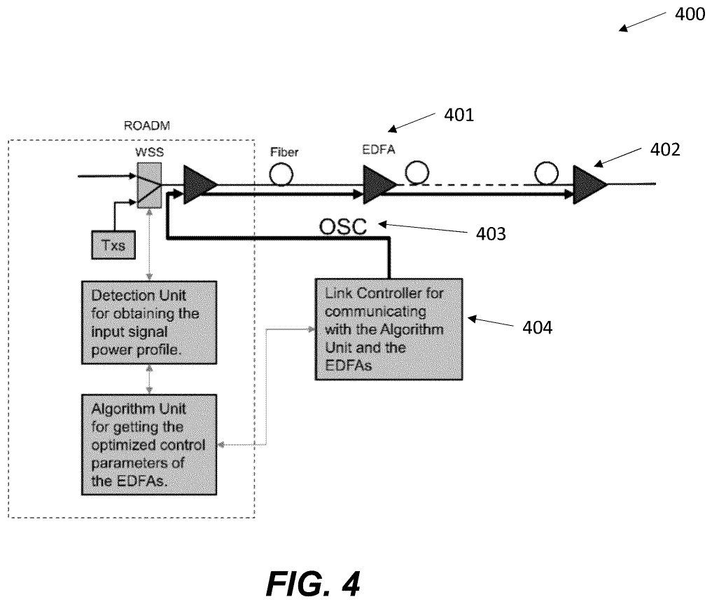

### FIG. 4—Embodiment 3

With reference to FIG. 4, there is depicted an architecture of another optical system 400 in accordance with a fourth embodiment. The optical system 400 comprises a Link Controller 404 that uses the OSC channel 403 to communicate with the EDFAs 401, 402 along the link.

Developers have realized that an OSC is a known communication channel in the optical communication system and the OSC is widely installed in the existing systems, therefore, using the OSC to communicate with the EDFAs can rely on the existing equipment and may not add additional cost.

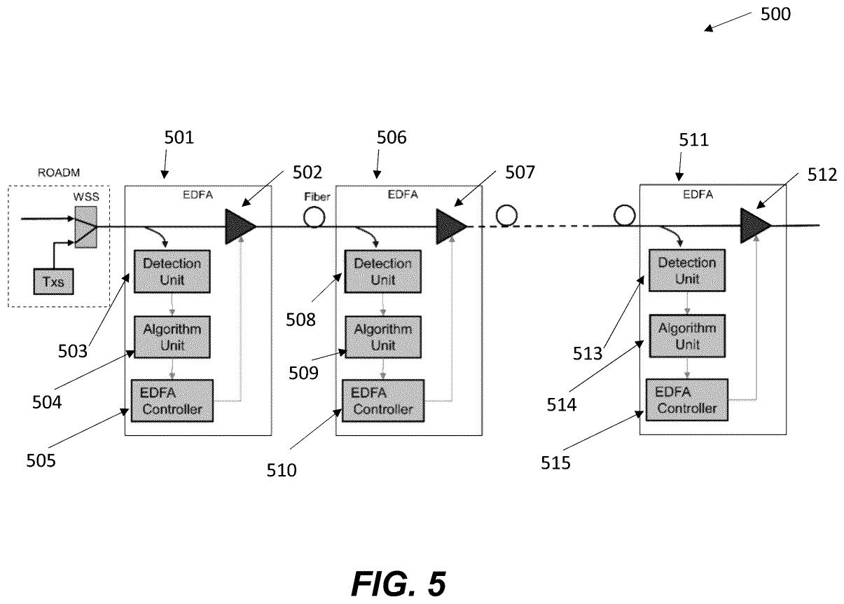

### FIG. 5—Embodiment 4

With reference to FIG. 5, there is depicted a further optical system 500 in accordance with a fourth embodiment. In the further optical system 500, The Detection Unit 503, 508, 513 and the Algorithm Unit 504, 509, 514 are integrated within an amplifier module 502, 507, 512 or within an amplification station 501, 506, 511. It should be noted EDFA Controller 505, 510, 515 has a similar functionality to a previous Link Controller 404 of FIG. 4.

Developers have realized that each EDFA 502, 507, 512 can be cognitive to the change of the input signal power profile. The reconfiguration of an EDFA 502, 507, 512 is usually within a time scale of several tens of microseconds.

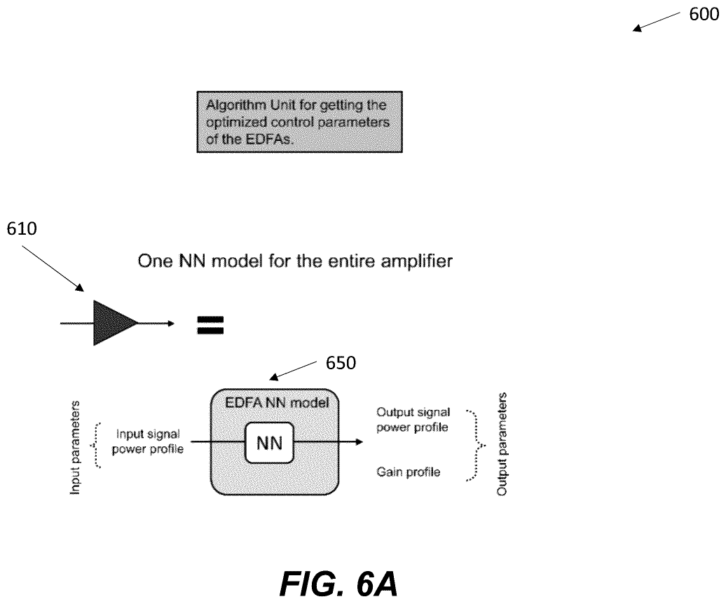

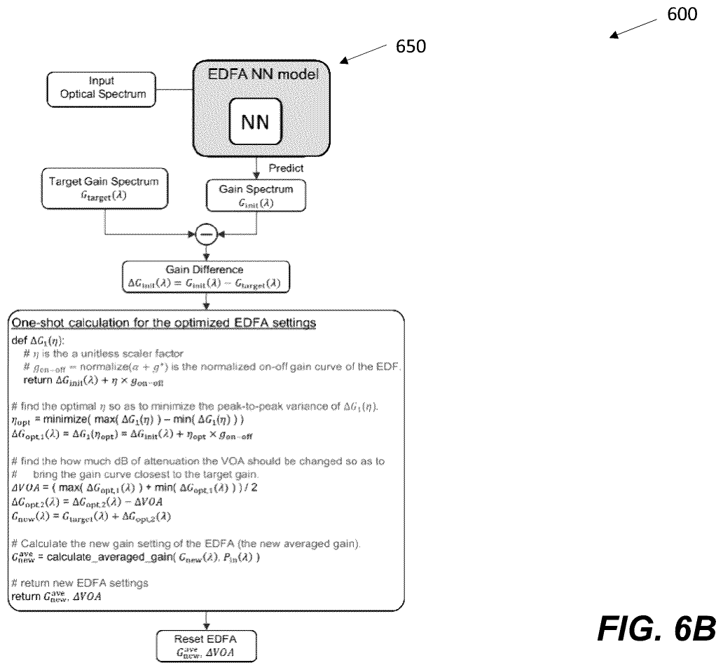

### FIG. 6A/B—Embodiment 5

With reference to FIGS. 6A and 6B, there is depicted an EDFA NN model 600, where one NN model 650 is used for the entire amplifier and the according control algorithm, as contemplated in a fifth embodiment of the present technology.

As depicted in FIG. 6B, the EDFA 610 works under the “gain-locking” mode. An NN gain model 650 for the EDFA 610 is pre-trained until acceptable precision is reached. Firstly, with the information of the input signal spectrum at hand, the NN model 650 predicts the original gain profile Gᵢₙᵢₜ(λ) of the EDFA 610. The original gain difference ΔGᵢₙᵢₜ(λ) is obtained by calculating Gᵢₙᵢₜ(λ)−G_{target}(λ). Then, we firstly minimize the peak-to-peak variance of Gᵢₙᵢₜ(λ) by ±a portion of the normalized α+g*(α and g* are the absorption and emission coefficients of the EDF, in the unit of dB/m), reaching a half-optimized gain deviation ΔG_{opt,1}(λ). Then, we translate ΔG_{opt,1}(λ) vertically by ΔVOA dB until its median equals zero. It is intuitive that we now have reached the optimal gain deviation, denoted by ΔG_{opt,2}(λ). The new gain profile G_{new}(λ) can be obtained by add ΔG_{opt,2}(λ) into G_{target}(λ). Finally, the gain settings of the EDFA 610 is updated: the gain locking point is modified to the averaged gain value of G_{new}(λ); the attenuation of the VOA is directly corrected by ΔVOA dB.

Developers have realized that the gain deviation can be improved on average by using some embodiments of the present technology, as seen in the appended article.

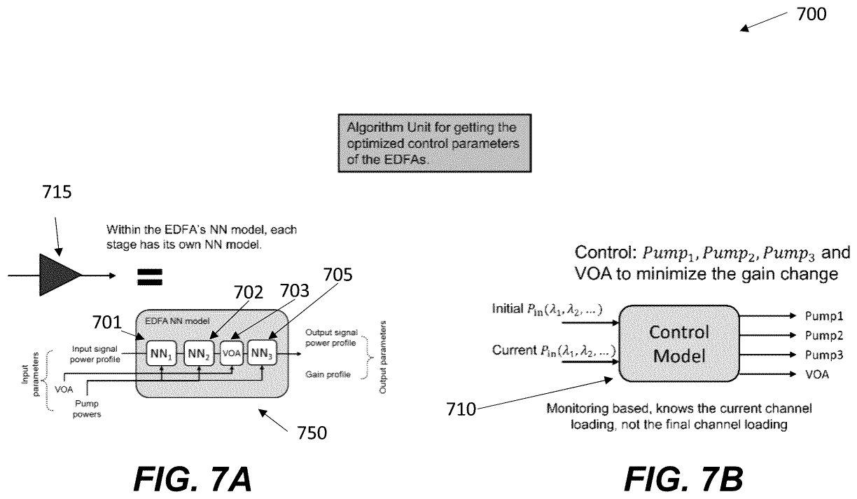

### FIG. 7A/B—Embodiment 6

With reference to FIGS. 7A and 7B, there is depicted another EDFA NN model 700 which comprises a set of NNs 701, 702, 705 for respective stages, and with pump power as a parameter, in accordance with sixth embodiment of the present technology. The NN model 701, 702, 705 of each stage is trained in a way that it works with non-flat input power. The NN models 701, 702, 705 for the amplification stages can be of the same architecture but have different parameters. The reason to use different NN model for each amplification stage is: 1) the EDF length of each amplification stage is different, the gain behavior changes from stage to stage; 2) each stage is controlled by a control parameter, mainly the pump power; in order to precisely control and to optimize the gain profile, the access to each control parameter by using separate NN models is needed.

In this embodiment, it can be said that the optical system may employ a monitoring-based algorithm. The monitoring-based algorithm knows the current channel loading, but the final channel loading is unknown. It takes the initial input signal power profile and the current input signal power profile as the input. These two inputs have some time delay. The control model 710 uses the EDFA's NN model 750 to tune the pump powers and the VOA 703 to minimize the gain change.

Developers have realized that compared to the fifth embodiment, this embodiment has access to all the control parameters of the EDFA 715, therefore, it allows better gain control. In the fifth embodiment, the SHB-induced gain distortion may not be compensated. In contrast, in this embodiment, the SHB-induced gain distortion can be compensated.

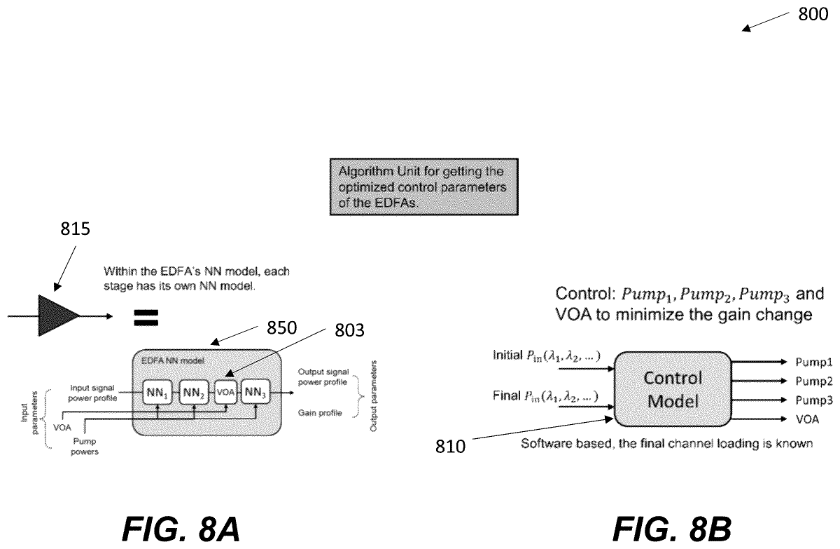

### FIG. 8A/B—Embodiment 7

With reference to FIGS. 8A and 8B, there is depicted a further EDFA NN model 800, but in which it is a software-based algorithm as opposed to a monitoring-based algorithm of the sixth embodiment. A software-based algorithm may know the final channel loading. It takes the initial input signal power profile and the final input signal power profile as the input. The control model 810 uses the NN model 850 of EDFA 815 to tune the pump powers and the VOA 803 to minimize the gain change.

Developers have realized that compared to the fifth embodiment, this embodiment has access to all the control parameters of the EDFA 815, therefore, it allows better gain control. In the fifth embodiment, the SHB-induced gain distortion may not be compensated. In contrast, in this embodiment, the SHB-induced gain distortion can be compensated.

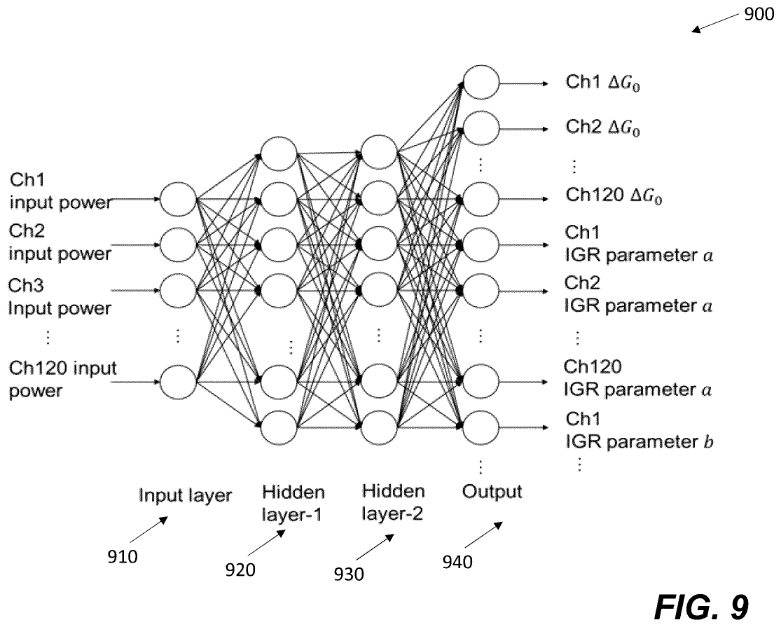

### FIG. 9—NN Architecture

With reference to FIG. 9, there is depicted an NN architecture 900 that can be used in at least some embodiments of the present technology.

NNs are a subset of machine learning models designed to mimic the human brain's architecture and function. They consist of layers of interconnected nodes or neurons, where each node represents a mathematical function. Data inputs are processed through these layers, where each node applies a specific computation, often involving weights and activation functions, to transform the input. The network learns by adjusting these weights based on the error of its output compared to the desired outcome, a process known as training.

The architecture of an NN can vary widely depending on inter alia a specific application, ranging from simple networks with one hidden layer to complex deep learning models with many layers. In some embodiments, an EDFA gain model may have an NN architecture referred to as Multilayer Perceptron (MLP).

The MLP may comprise an input layer 910. This layer 910 receives raw input features, which could be parameters affecting the amplifier's gain, such as the target averaged gain level, the electrical currents of the pump diodes, the signal powers, the attenuation value of the VOA, etc.

The MLP may comprise hidden layers 920, 930. One or more hidden layers 920, 930 can be used to process the inputs. These layers are typically fully connected, meaning each neuron in one layer is connected to all neurons in the next layer. The number of hidden layers and the number of neurons in each layer are design choices that depend on the complexity of the relationship between the inputs and the amplifier's gain. For instance, two hidden layers with 30-50 neurons each might be sufficient to capture the nonlinear relationships in the data.

The MLP may comprise activation functions. Activation functions introduce non-linearities into the model which are crucial for learning complex patterns. Common choices include ReLU (Rectified Linear Unit) for hidden layers, which helps with faster convergence and avoids the vanishing gradient problem, and a linear activation function in the output layer if the task is to predict a continuous value such as gain.

The MLP may comprise an output layer 940. The output layer 940 have multiple neurons, each to predict the gain of an optical signal channel, as well as to predict other features of the amplifier, such as the noise figure. The activation function might be linear since the gain is likely a continuous variable.

The MLP may comprise a loss function and optimization processes. The loss function could be Mean Squared Error (MSE) if the objective is to minimize the error between the predicted and actual gain values, for example. An optimizer like Adam or SGD (Stochastic Gradient Descent) would be used to update the weights based on the gradient of the loss function.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. An optical system, comprising:
a detection unit for detecting an input signal power profile;
an algorithm unit for acquiring information of the input signal power profile and calculating a set of optimal control parameters for an Erbium Doped Fiber Amplifier (EDFA) along a link of the optical system;
a link controller for acquiring the information of the set of optimal control parameters of the EDFA and configuring the EDFA.

2. The optical system of claim 1, wherein the detection unit includes a Light Sensor (LS).

3. The optical system of claim 1, wherein the detection unit includes a spectrometer.

4. The optical system of claim 1, wherein the detection unit is included in a Reconfigurable Optical Add-Drop Multiplexer (ROADM) station of an optical network.

5. The optical system of claim 1, wherein the detection unit is a plurality of detection units integrated in an EDFA module or in an amplification station of an optical network.

6. The optical system of claim 1, wherein the algorithm unit includes a Neural Network (NN) model for the EDFA, and wherein the optical system is configured to:
combine the NN model with a physical model by a control algorithm to calculate an optimal averaged gain level and an optimal VOA attenuation for the EDFA.

7. The optical system of claim 1, wherein the algorithm unit includes a complex NN model for the EDFA, in which:
each amplification stage has its own NN model and each NN model is trained for nonuniform signal input, each NN model takes the input signal power profile, a set of pump powers and a Variable Optical Attenuator (VOA) attenuation as inputs, and predicts a signal gain and an output signal power profile.

8. The optical system of claim 1, wherein the algorithm unit includes a complex NN model for the EDFA, in which:
a control algorithm is a monitoring-based algorithm which acquires an initial input signal power profile and a current input signal power profile as inputs, where the two inputs have time delay, and a control model uses an NN model to tune a set of pump powers and a VOA attenuation.

9. The optical system of claim 1, wherein the algorithm unit includes a complex NN model for the EDFA, in which:
a control algorithm is a software-based algorithm which acquires an initial input signal power profile and a final input signal power profile as inputs, wherein a control model uses an NN model to tune a set of pump powers and a VOA attenuation.

10. The optical system of claim 1, wherein the link controller is located in a ROADM station, and wherein the link controller uses an Optical Supervisory Channel (OSC) to communicate with EDFA along the link.

11. The optical system of claim 1, wherein the link controller is a plurality of link controllers, each of which is integrated in an EDFA module, or in an amplification station as an EDFA controller.

12. A method for configuring an Erbium Doped Fiber Amplifier (EDFA), comprising:
detecting an input signal power profile;
calculating, using a Neural Network (NN) model combined with a physical model, one or more optimal control parameters for an EDFA along a link of an optical system using the input signal power profile; and
configuring the EDFA using the one or more optimal control parameters.

13. The method of claim 12, wherein the detecting the input signal power profile includes employing a light sensor.

14. The method of claim 12, wherein the detecting the input signal power profile includes employing a spectrometer.

15. The method of claim 12, wherein the detecting the input signal power profile occurs in a Reconfigurable Optical Add-Drop Multiplexer (ROADM) station of an optical network.

16. The method of claim 12, wherein the detecting the input signal power profile occurs in an EDFA module or in an amplification station of an optical network.

17. The method of claim 12, wherein the one or more optimal control parameters include an optimal averaged gain level and an optimal Variable Optical Attenuator (VOA) attenuation for the EDFA.

18. The method of claim 12, wherein the method further comprises:
training a plurality of NN models for nonuniform signal input, each of the plurality of NN models being associated with an amplification stage, each of the plurality of NN models taking the input signal power profile, a set of pump powers and a VOA attenuation as inputs; and
predicting a signal gain and an output signal power profile.

19. The method of claim 12, wherein the method further comprises:
acquiring an initial input signal power profile and a current input signal power profile as inputs, where the inputs have time delay;
and tuning a set of pump powers and a VOA attenuation using an NN model.

20. The method of claim 12, wherein the method further comprises:
acquiring an initial input signal power profile and a final input signal power profile as inputs;
and tuning a set of pump powers and a VOA attenuation using an NN model.
